(19) United States
(12) Patent Application Publication
(10) Pub. No.: US 2012/0116561 A1
(43) Pub. Date: May 10, 2012

(54) PROGRAM TESTING APPARATUS, METHOD OF TESTING A PROGRAM, AND PROGRAM TESTING PROGRAM

(75) Inventor: Koichi NAKAGAWA, Tokyo (JP)

(73) Assignee: MITSUBISHI ELECTRIC CORPORATION, Chiyoda-ku (JP)

(21) Appl. No.: 13/042,749

(22) Filed: Mar. 8, 2011

(30) Foreign Application Priority Data
Nov. 8, 2010 (JP) 2010-249880

(51) Int. Cl. G06F 19/00

(52) U.S. Cl. 700/97

(57) ABSTRACT

A program testing apparatus includes a program input section for receiving externally inputted program codes corresponding to system components disposed hierarchically in accordance with a plant system configuration to divide a program to be tested which is inputted from an input section into a plurality of modules on a function-by-function basis, based on the system components, and a program retrieving section for retrieving a program having a predetermined relationship to a program corresponding to one of the system components, based on system information.

### BACKGROUND OF THE INVENTION

1. Field of the Invention

The present invention relates to a program testing apparatus, a method of testing a program and a program testing program which make a test on programs in a system such as a plant where a large number of operation instruments such as pumps and valves and a large number of sensors such as flowmeters and pressure gauges are disposed, the programs to be tested including a program for a computer which permits an operator who monitors operating data detected by the sensors to grasp the state of the plant in an instant and to operate the operation instruments, thereby aiding in the stable operation of the plant, and a program known as a sequence control program written generally in a ladder language and a POL (Problem Oriented Language).

2. Description of the Background Art

First, terms for use in the present invention will be defined. The term “system components” of a plant means, for example, physically and functionally hierarchically classified components. For example, the system components of a sewage treatment plant are physically divided into a primary sedimentation tank, a reaction tank, a final sedimentation tank, and the like (See a glossary of sewage terms issued by Japan Sewage Works Association). Pumps, valves, sensors and the like are installed in each of such facilities. These pumps, valves, sensors and the like are defined as devices in the present invention. The devices constitute a group for each process or treatment. For the process of withdrawing sludge in the primary sedimentation tank, for example, devices including a sludge pump, a water conveyance pump, and a withdrawal valve perform a single process. In the present invention, a group composed of such devices is generically defined as a system. Thus, a plant is composed of hierarchical functions including facilities, systems, and devices.

It is also disclosed in, for example, Japanese Patent Application Laid-Open No. 5-241617 (1993) (FIG. 1) that a plant is composed of hierarchical components. The components including facilities, systems, and devices that constitute a plant have corresponding functions at respective levels. For example, the process of controlling the start and stop of a sludge withdrawal process is at a facility level, the process of operating a pump and a valve for sludge withdrawal is at a system level, and the process of controlling a pump and a valve is at a device level. In the present invention, the components that constitute a plant, such as facilities, systems and devices, are referred to as functions for purposes of convenience.

The term “script” used in the present invention refers to a simplified language which needs no compile and is easy to learn and in which a control structure such as a conditional jump can be described, unlike a command in which instructions are described successively. The term “program” used in the present invention means a sequence control program written in a ladder language and a POL.

A plant is provided with a large number of large-size systems such as boilers and electric generators. In each of the systems are placed a large number of devices including operation instruments such as pumps and valves, and sensors such as pressure gauges and flowmeters. For the monitoring of the operating conditions of the plant, signals of the devices are allocated to graphic symbols displayed on a GUI (Graphic User Interface) screen showing a flow diagram and a system configuration diagram, and an operator monitors current values in a room known as a central monitoring room or recognizes failures occurring in the devices in the form of messages or in graphic form, and then manipulates the operation instruments. A computer known as a PLC (programmable logic controller) is installed on the site of such a plant. While performing computations using the values of the respective sensors, the computer executes a program for controlling the devices of the plant in accordance with instructions of the operator present in the central monitoring room.

For testing the above-mentioned program, the operator often visually recognizes behaviors (operations) while principally manipulating and setting values manually by using a simulator that simulates the values of the signals. Also, it is necessary to make an operation check of all signals connected to the plant because importance is placed on the reliability of the plant. Some plants have and handle hundreds of to tens of thousands of signals, depending on the scale thereof. The increase in the number of tests to be made causes the increase in the scale of the program, which in turn makes debugging and maintenance thereof more difficult.

There has been a test of this type which achieves the reduction in test costs by automatically generating a program for setting required test data, as disclosed in, for example, Japanese Patent Application Laid-Open No. 2005-63425 (FIG. 7). The test requires two programs: a first program for setting test data, and a second program for evaluating a result outputted from the first program. Japanese Patent Application Laid-Open No. 2005-63425 discloses a technique such that an input/output variable extraction section extracts a variable serving as an input from a program (a ladder program) to be tested which is held in a to-be-tested ladder management section, whereby a virtual input ladder generating section automatically generates a program for setting test data. In this technique, a test input sequence management section allows a user to generate a program for evaluating an output result only by specifying a simple command and parameters. This enables the user to make a test if he or she does not know the ladder language which requires relatively highly sophisticated knowledge.

There is disclosed another technique in which the hierarchical system specifications of a plant are previously prepared to allow a user to easily input control specifications of a control program, as disclosed in, for example, Japanese Patent Application Laid-Open No. 5-241617 (1993) (FIG. 1).

There is still another technique in which the influence of a change made to a program is easily understood by following the variables of the program although the program is not a control program, as disclosed in, for example, Japanese Patent Application Laid-Open No. 6-214764 (1994) (FIG. 12).

In the technique disclosed in Japanese Patent Application Laid-Open No. 2005-63425, the design of the program (procedure) for evaluating the test result does not require the knowledge of a method of writing a ladder program as a program language, but is not performed without internal information about the program comparable to that of a program designer, such as information about the basic operation of a sequence program, about the dependence relationship between sub-modules in a program, and about which and where variables are referred to. Additionally, this technique is capable of handling only simple verification of the test results such as the comparison with a normal value, and is not capable of specifying programmable conditions, such as combining a plurality of conditions together, considering time and a change in state, and using a test result under a condition as input data for another condition.

In the technique disclosed in Japanese Patent Application Laid-Open No. 5-241617 (1993), it is necessary to previously prepare data in which the system components of the plant are defined hierarchically on a function-by-function basis or on a device-by-device basis.

In the technique disclosed in Japanese Patent Application Laid-Open No. 6-214764 (1994), a program influenced by changing the program is found by following the variables. Thus, the increase in the number of variables being used or the complicated relationship between the programs exerts an effect on performance. Also, this technique is not capable of detecting a program which does not directly use variables but which structurally resembles a program in which a modification is made due to errors and the like.

### SUMMARY OF THE INVENTION

It is therefore an object of the present invention to provide a program testing apparatus, a program testing method and a program testing program which are capable of conducting a program test under programmable conditions and preventing the occurrence of program errors.

According to a first aspect of the present invention, a program testing apparatus includes an input section, a display section, a controller, and a test database. The controller includes a program input section, a program analyzing section, a test entry screen generating section, a test editing section, a program retrieving section, and a test program executing section. The program input section receives externally inputted program codes corresponding to system components disposed hierarchically in accordance with a plant system configuration to divide a program to be tested which is inputted from the input section into a plurality of modules on a function-by-function basis, based on the system components. The program analyzing section analyzes each of the modules to acquire system information about the system components based on the plant system configuration corresponding to each module and to acquire variable information for use in each module, based on the system information, thereby storing module information including the system information and the variable information in the test database. The test entry screen generating section produces a test entry screen for entry of a test logic and test data that are required for the execution of a program test for each module from the input section, by using the module information stored in the test database, to store test entry screen information for the construction of said test entry screen in the test database. The test editing section causes the test entry screen to appear on the display section by using the test entry screen information, and produces a test program from the test logic entered using the test entry screen to store the produced test program and the entered test data in the test database. The program retrieving section retrieves a program having a predetermined relationship to a program corresponding to one of the system components, based on the system information. The test program executing section executes the test program by using the test data stored in the test database to store a test result in the test database.

A second aspect of the present invention is intended for a method of testing a program using a program testing apparatus. According to the present invention, the method includes the following steps (a) through (g). The step (a) is to receive externally inputted program codes corresponding to system components disposed hierarchically in accordance with a plant system configuration to divide an inputted program to be tested into a plurality of modules on a function-by-function basis, based on the system components. The step (b) is to analyze each of the modules to acquire system information about the system components based on the plant system configuration corresponding to each module and to acquire variable information for use in each module, based on the system information. The step (c) is to store module information including the system information and the variable information acquired in the step (b) in a test database. The step (d) is to produce a test entry screen for entry of a test logic and test data that are required for the execution of a program test for each module, by using the module information stored in the test database, to store test entry screen information for the construction of said test entry screen in the test database. The step (e) is to cause the test entry screen to appear on a display section by using the test entry screen information, and to produce a test program from the test logic entered using the test entry screen to store the produced test program and the entered test data in the test database. The step (f) is to retrieve a program having a predetermined relationship to a program corresponding to one of the system components, based on the system information. The step (g) is to execute the test program by using the test data stored in the test database to store a test result in the test database.

A third aspect of the present invention is intended for a program testing program for causing a computer to function as a program testing apparatus. The program testing program causes the computer to execute the following steps (a) through (h). The step (a) is to receive externally inputted program codes corresponding to system components disposed hierarchically in accordance with a plant system configuration to divide an inputted program to be tested into a plurality of modules on a function-by-function basis, based on the system components. The step (b) is to analyze each of the modules to acquire system information about the system components based on the plant system configuration corresponding to each module and to acquire variable information for use in each module, based on the system information. The step (c) is to store module information including the system information and the variable information acquired in the step (b) in a test database. The step (d) is to produce a test entry screen for entry of a test logic and test data that are required for the execution of a program test for each module, by using the module information stored in the test database, to store test entry screen information for the construction of said test entry screen in the test database. The step (e) is to cause the test entry screen to appear on a display section by using the test entry screen information to enter the test logic and the test data. The step (f) is to produce a test program from the test logic entered in the step (e). The step (g) is to retrieve a program having a predetermined relationship to a program corresponding to one of the system components, based on the system information. The step (h) is to execute the test program by using the test data entered in the step (e) to store a test result in the test database.

According to the present invention, the controller includes: the program input section for receiving externally inputted program codes corresponding to system components disposed hierarchically in accordance with a plant system configuration to divide a program to be tested which is inputted from the input section into a plurality of modules on a function-by-function basis, based on the system components; the program analyzing section for analyzing each of the modules to acquire system information about the system components based on the plant system configuration corresponding to each module and to acquire variable information for use in each module, based on the system information, thereby storing module information including the system information and the variable information in the test database; the test entry screen generating section for producing a test entry screen for entry of a test logic and test data that are required for the execution of a program test for each module from the input section, by using the module information stored in the test database, to store test entry screen information for the construction of said test entry screen in the test database; the test editing section for causing the test entry screen to appear on the display section by using the test entry screen information, and for producing a test program from the test logic entered using the test entry screen to store the produced test program and the entered test data in the test database; the program retrieving section for retrieving a program having a predetermined relationship to a program corresponding to one of the system components, based on the system information; and the test program executing section for executing the test program by using the test data stored in the test database to store a test result in the test database. This enables the program test to be conducted under programmable conditions including combining a plurality of conditions together using a script, considering time and state change, and using a test result under a condition as input data of another condition, thereby preventing the occurrence of program errors. Also, there is no need to previously produce the specifications of a plant because programs can be inputted in association with the specifications of the plant. Further, a relationship between the programs is analyzed in accordance with the specifications of the plant. This enables a related program to be easily found, independently of the volume of variables of the program.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram schematically showing a program testing apparatus according to a first preferred embodiment of the present invention;

FIG. 2 is a view showing an example of the data structure of system information in a database according to the first preferred embodiment of the present invention;

FIG. 3 is a view showing an example of the data structure of module information in the database according to the first preferred embodiment of the present invention;

FIG. 4 is a block diagram schematically showing a hardware configuration of the program testing apparatus according to the first preferred embodiment of the present invention;

FIG. 5 is a flowchart showing the operation of a program input section according to the first preferred embodiment of the present invention;

FIGS. 6A, 6B, 7C, 7D, 8E and 8F are views showing examples of a program entry screen according to the first preferred embodiment of the present invention;

FIG. 9 is a view showing an example of the data structure of the module information according to the first preferred embodiment of the present invention;

FIG. 10 is a view showing an example of the generation of a test data input section of a test entry screen according to the first preferred embodiment of the present invention;

FIG. 11 is a flowchart showing the operation of a test entry screen generating section according to the first preferred embodiment of the present invention;

FIG. 12 is a view showing an example of the generation of a logic input section of the test entry screen according to the first preferred embodiment of the present invention;

FIG. 13 is a view showing an example of the test entry screen according to the first preferred embodiment of the present invention;

FIG. 14 is a view showing an example of a test execution result according to the first preferred embodiment of the present invention;

FIG. 15 is a diagram showing an example of the structure of a plant for reference by a program retrieving section according to a second preferred embodiment of the present invention;

FIG. 16 is a flowchart showing the operation of the program retrieving section according to the second preferred embodiment of the present invention; and

FIG. 17 is a view showing an example of the program entry screen according to the second preferred embodiment of the present invention.

### DESCRIPTION OF THE PREFERRED EMBODIMENTS

Preferred embodiments according to the present invention will now be described with reference to the drawings.

### First Preferred Embodiment

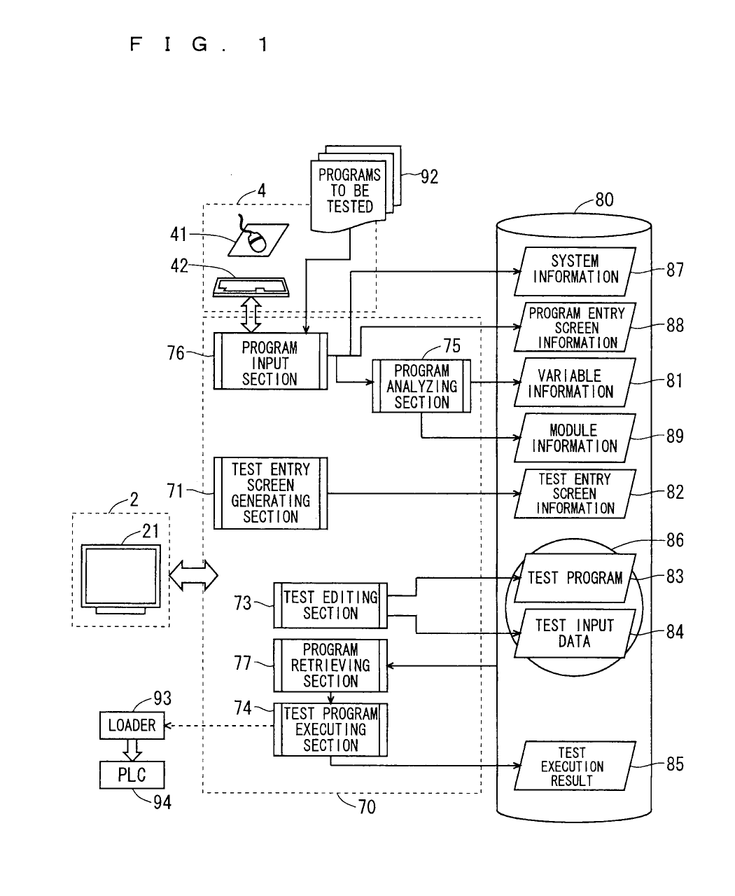

FIG. 1 is a block diagram schematically showing a program testing apparatus according to a first preferred embodiment of the present invention. The program testing apparatus includes a test database 80, a controller 70, an input section 4 via which an operator is permitted to enter data into the program testing apparatus, and a display section 2 for displaying an output result in graphic or text form. The controller 70 is executed by a computer using a program. In other words, the controller 70 is synonymous with a program testing program for testing a control program. Data about a test is inputted from the input section 4 to the controller 70, and an output result of the test is outputted to the display section 2. Programs 92 to be tested are inputted from the input section 4. At this time, the programs 92 to be tested are inputted in association with systems and devices constituting a plant. Thus, the controller 70 divides each program 92 to be tested into some modules, and divides test data to be set to variables of each module and logics to be specified for the test on a system-by-system basis or on a device-by-device basis to store the divided data and logics in the test database 80. The controller 70 also analyzes each program 92 to be tested to store information on variables (variable information 81) declared in each program 92 to be tested. When a recorded test program is executed, a test execution result 85 is stored in the test database 80.

The test database 80 manages data about the test. System information 87 represents specifications of the plant in the form of a hierarchical data structure, and manages information as to which facility constitutes the plant, as to which systems are provided in the facility, and as to which devices constitute each of the systems. Program entry screen information 88 is such that a screen on which a program can be entered in association with a function is in the form of data displayable by the display section 2. The variable information 81 manages information as to which variable is present in each program 92 to be tested and as to how the variable is used. A test program 83 is a test logic written using a lightweight language such as a script, and is managed on a module-by-module basis. Test entry screen information 82 is such that a screen on which a test can be entered in association with a function is in the form of data displayable by the display section 2. Test input data 84 is managed on a module-by-module basis, and stores the values of a variable of each module for each test program stored in the test program 83. The test program 83 is converted by a loader 93 into a format executable by a PLC (programmable logic controller) 94, and is executed together with each program 92 to be tested in the PLC 94. The executed result is recorded for each associated function, for each test execution unit (for each count of execution times on that date), and for each version, and is managed as the test execution result 85.

The controller 70 in the program testing apparatus according to the first preferred embodiment of the present invention operates generally in a manner to be described below.

First, a program input section 76 generates a program entry screen in accordance with a function inputted from the input section 4. The program entry screen may be a screen generated using a markup language which is produced for each function, and the like. When the inputted function is not present in the system information 87, a new program entry screen is produced. The produced program entry screen is stored in a data format as the program entry screen information 88 in the test database 80.

After the program entry screen is produced, a program 92 to be tested is inputted. A program analyzing section 75 analyzes variables used in the program 92 to be tested and the usage of the variables. The process of dividing a program by the program input section 76 may be performed using a well-known program analysis tool. However, an operator performs the process of dividing a program by interaction while entering components of the plant and their corresponding program codes in accordance with a system configuration of the plant regarding which system or device an inputted program code is associated with (corresponds to) or which system configuration the system or device has. This is a characteristic of the present invention.

The attributes of the respective variables used in each module are obtained from information provided by analyzing the program. An entry screen (markup text generation) of variables included in each module is constructed in accordance the attributes. In this process, an alias is added to each of the variables automatically or by entering the alias on an entry screen. This alias is used to identify a corresponding variable when the test is described. A description about the variable is also entered by the operator, and is stored together with the alias as part of the variable information 81 in the test database 80. It should be noted that information obtained by the analysis is sufficient as the variable information in some cases, and the variable information need not always be obtained by the entry.

After the analysis of the program is all completed, a test entry screen generating section 71 generates screens for the entry of test data and test logics. The entry screen may be attained by generating a markup language such as an HTML (Hyper Text Markup Language). The program entry screen may also be attained by generating the same using a markup language. The entry screen for the test data and the entry screen for test logics are combined together to generate a test entry screen. The generated test entry screen is stored in a data format as the test entry screen information 82 in the test database 80.

In this manner, preparations for testing the program 92 to be tested are done. Next, the test entry screen showing what test is to be conducted is actually displayed on the display section 2 by using the generated test entry screen information 82, and the operator enters necessary information from the input section 4. Specifically, in a test editing section 73, the operator enters the test data to be edited for each test and the logic of each test to be executed by using the generated test entry screen from the input section 4.

The test logic entered on the entry screen is inputted as a script that can be written in a markup language, such as ECMA JavaScript (a registered trademark), Microsoft VBScript and Adobe ActionScript, rather than the markup language. A test verification logic is written using a syntax using the above-mentioned alias of the variable. In this manner, the test logic can be written in a script having a control structure. Thus, the verification logic is written easily which has been difficult to write in a ladder program having only a low power of expression close to that of a machine language. The test editing section 73 combines the entered logic and a program for accessing the variables of the program using the aliases together to generate the test program 83, thereby recording the test program 83 together with the test input data 84 in the test database 80.

A test program executing section 74 executes the test program 83 using the test input data 84 recorded in the test database 80 to conduct a test, thereby recording the test execution result 85 in the test database 80.

Until the step of preparing the test among the above-mentioned steps, it is necessary for an operator having a program knowledge about the program 92 to be tested to enter, for example, the description about the variables and the functions. However, an operator having no program knowledge about the program 92 to be tested but having a minimum knowledge about scripts may execute the step of entering what test is to be conducted and the step of conducting the test, that is, the stage of actually conducting a program test.

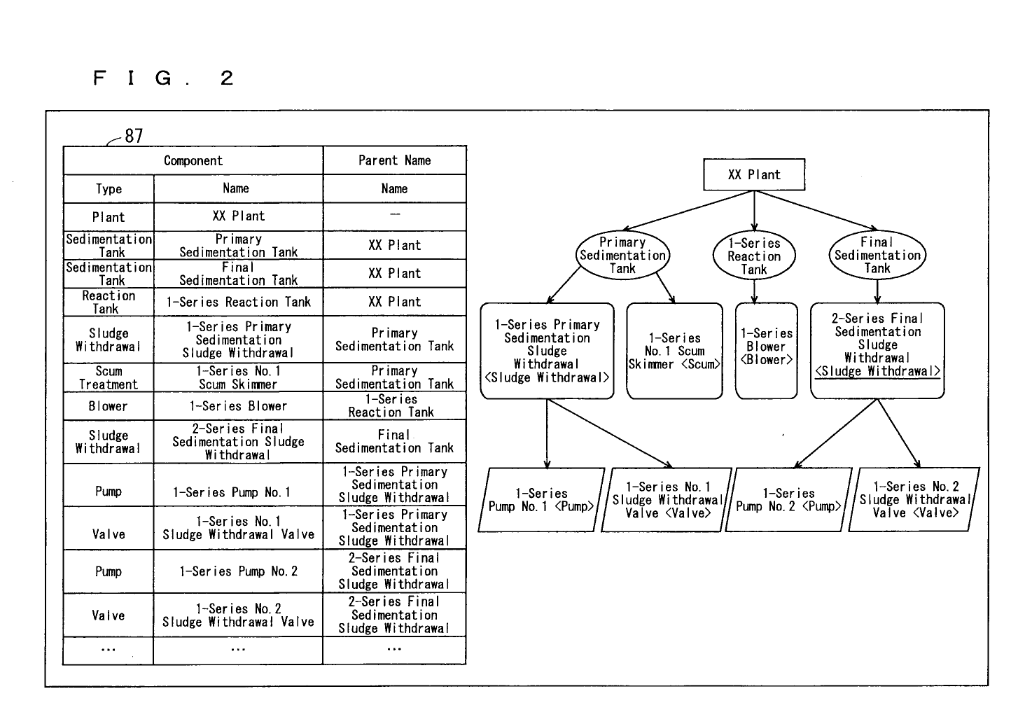

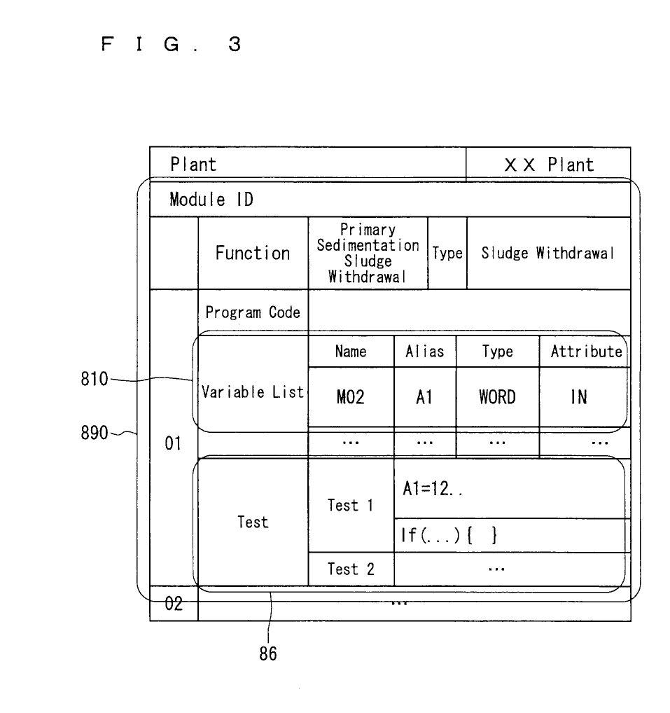

FIGS. 2 and 3 show a specific construction of the test database 80. As shown in FIG. 2, the test database 80 has an area in which the system information 87 about the components constituting each plant is stored. FIG. 2 shows that an “XX plant” as a target incorporates three facilities, i.e. a “primary sedimentation tank,” a “reaction tank” and a “final sedimentation tank,” each of which has at least one system. For example, it is shown that the “primary sedimentation tank” has a system for performing a “1-series primary sedimentation sludge withdrawal process,” and this system has two devices: a “1-series pump No. 1” and a “1-series No. 1 sludge withdrawal valve.”

Each of the components has a function type as well as the above-mentioned name. For example, a component has a device type referred to as a “pump,” and another component has a system type referred to as “sludge withdrawal.” The sludge withdrawal refers to the process of removing sludge from a sedimentation tank by a pump. This process have different names depending on whether the position of the sedimentation tank is the primary sedimentation tank or the final sedimentation tank. However, the primary sedimentation tank and the final sedimentation tank perform the same process, and may be considered to be of the same type in terms of control.

As shown in FIG. 3, a test information area 86, a variable information area 810, and an inputted program code are collectively managed for each function, and are stored as module information 89 in a module area 890 contained in the test database 80. The module area 890 has the variable information area 810, and the test information area 86 for storing test information. All of the test input data 84 and the test program 83 for use in the module are stored in the test information area 86. The program 92 to be tested which is inputted by the program input section 76 is held while being divided on a function-by-function basis. The function of the plant directly corresponding to each module is stored in each module. In FIG. 3, the “primary sedimentation sludge withdrawal” is the function corresponding to the module, and this function is a function defined by the system information 87 shown in FIG. 2. The inputted program code is stored in the area denoted as the code. Attributes (name, type name, alias and the like) for the variables used in each module, and the usage of the variables (input variable, output variable, value reference) are stored in the variable information area 810. (In other words, the variable information 81 is stored in the variable information area 810.) In this manner, each piece of information is stored in association with a corresponding module, and the module information 89 includes information (the system information 87) about the function to be performed by the module. As a result, each piece of information is managed on a function-by-function basis.

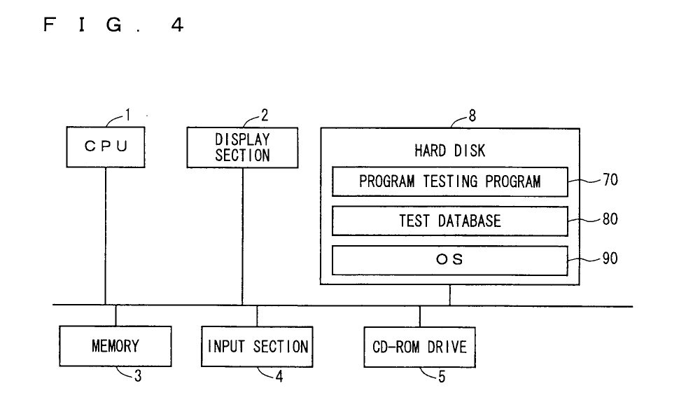

FIG. 4 shows a hardware (computer) configuration in which the program testing apparatus of FIG. 1 is implemented using a computer including a CPU and the like. With reference to FIG. 4, a memory 3, the display section 2 including a display 21, the input section 4 including a mouse 41 and a keyboard 42, and a hard disk 8 are connected to a CPU 1. A program testing program for performing the function of the controller 70 shown in FIG. 1, the test database 80, and an operating system (OS) 90 are recorded on the hard disk 8. The program testing program (controller) 70 is installed, for example, from a recording medium onto the hard disk 8. An instance in which the program testing program (controller) 70 is installed from a CD-ROM through a CD-ROM drive 5 onto the hard disk 8 is illustrated in FIG. 4.

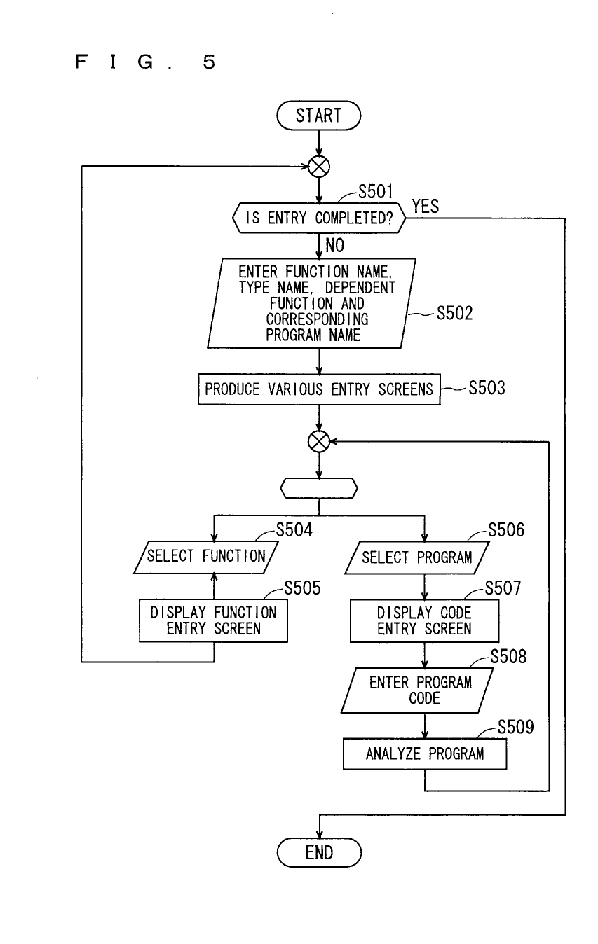

FIG. 5 is a flowchart showing the outline of the operation of the controller (program testing program) 70. The program testing program 70 performs processes in cooperation with the operating system 90. First, the CPU 1 causes a blank program entry screen (with nothing entered thereon) to appear. In Step S501, when an entry is completed, the operation is terminated. When an entry is to be made, a function name, a dependent function, a corresponding program name and a function type are entered (in Step S502). In Step S503, when the function entered in Step S502 is a function having already been entered, a hyperlink to a screen related to the function is created. When the function entered in Step S502 is a new function, a new entry screen is produced. When a program name is included in Step S502 and the program has already been entered, a hyperlink to a corresponding code entry screen is created. When a program name is included in Step S502 and the program has not yet been entered, a new screen is produced. In this manner, in Step S503, an entry screen is created in accordance with the information entered in Step S502 or a hyperlink to a screen is created. In Step S504, clicking on (selecting) a hyperlink related to the displayed function causes a function entry screen to appear (in Step S505). In Step S506, clicking on (selecting) a hyperlink related to the displayed program causes a code entry screen to appear (Step S507). Then, an operator enters a program code (in Step S508). In Step S509 is performed the process of analyzing the entered program code to retrieve variable information, a related program, a dependent program, and a similar program, thereby creating a hyperlink to a corresponding program code entry screen.

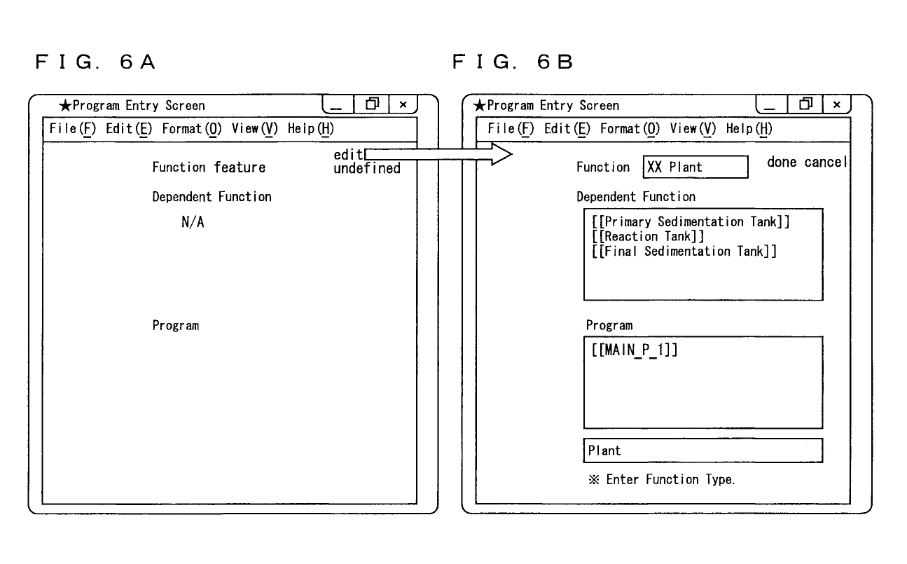

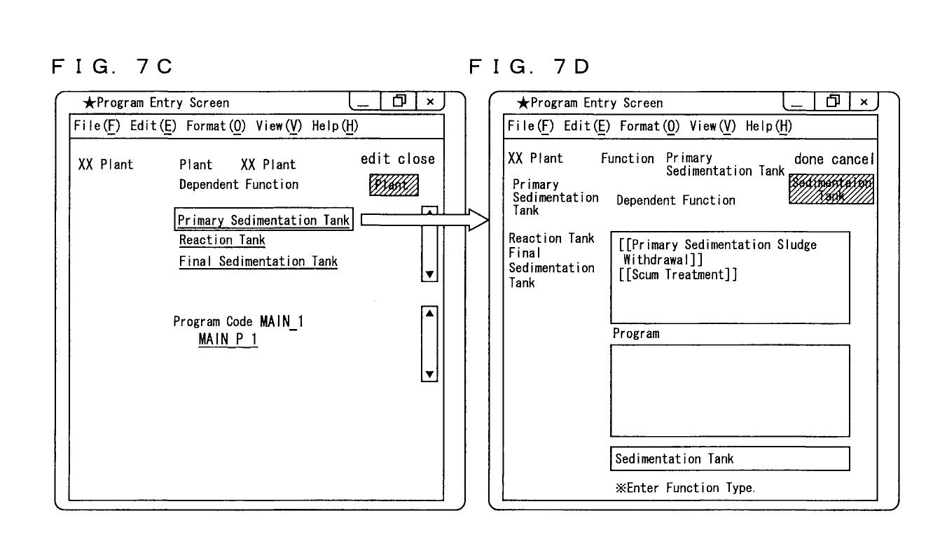

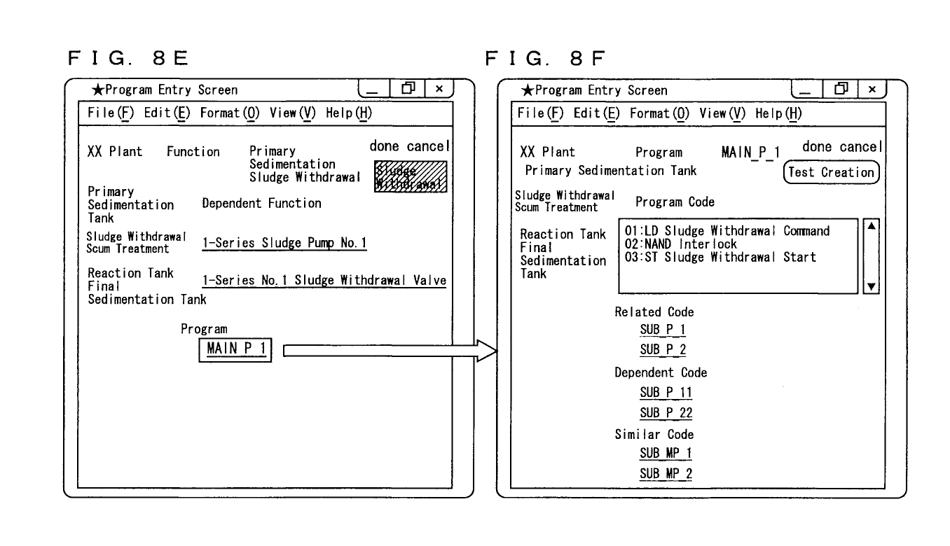

FIGS. 6A, 6B, 7C, 7D, 8E and 8F are views showing examples of the program entry screen. As shown in FIGS. 6A, 6B, 7C, 7D, 8E and 8F, the operator enters program codes corresponding to respective components while defining the system configuration of the plant. FIG. 6A shows a blank entry screen (with nothing entered thereon). Clicking on (selecting) an “edit” command shown in FIG. 6A changes the blank entry screen to an entry screen as shown in FIG. 6B. With reference to FIG. 6B, the operator enters “XX Plant” which is the first functional element (component). A hyperlink to each of the functions (components) dependent on this function is constructed using a description in Wild format and the like. In FIG. 6B, the dependent functions are written using “[[” and links to the primary sedimentation tank, the reaction tank and the final sedimentation tank are written. The function type in this case is “Plant.” The Wiki format is documented in Help for Wikipedia (http://ja.wikipedia.org/). Clicking on “done” on the entry screen of FIG. 6B changes the entry screen to a screen as shown in FIG. 7C. A hyperlink to each of the functions entered in FIG. 6B is created with an underline. The entered type is displayed in a shaded area beside the function name (and is displayed as “Plant” in FIG. 7C). Clicking on “Primary Sedimentation Tank” shown in FIG. 7C changes the screen to a screen as shown in FIG. 7D. As illustrated in FIG. 7D, the system configuration of the plant is hierarchically displayed on the left-hand side of the screen. Also, as shown in FIG. 8E, not only the functions but also the program is displayed in the form of respective hyperlinks. Clicking on “MAIN_P_{—}1” on the screen of FIG. 8E changes the screen to a screen for the entry of program codes as shown in FIG. 8F. An instance in which the program codes regarding the primary sedimentation sludge withdrawal are entered is shown in FIG. 8F. Also, a related program, a dependent program and a similar program which will be described later are retrieved and displayed in the form of respective hyperlinks on the screen of FIG. 8F. Clicking on “done” on the screen of FIG. 8F completes the entry of the program.

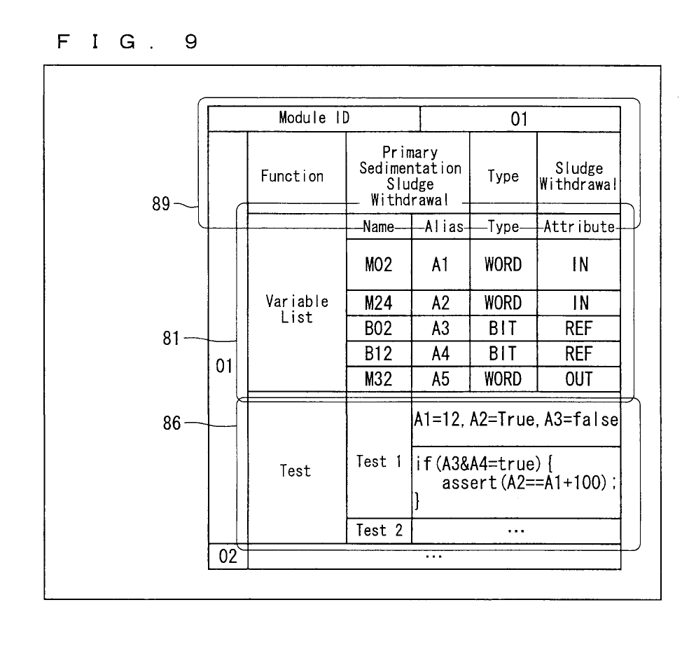

FIG. 9 shows an example of the variable information 81 in the test database 80. In the module shown in FIG. 9, variables M02, M24, B02 and B36 are detected by the program analyzing section 75. The variable M02 or the like is an identifier for a memory address in a ladder program. Addresses are often changed when a program is written. For this reason, an alias such as A1 added to the variable M02 is used during the writing of a test. It is found that the type of the variable M02 is a WORD-type, and that the variable M02 is a 16-bit long variable and is used as an input variable for the module. The character “IN” in the “Attribute” column indicates that the variable is used as an input variable, “OUT” indicates that the variable is used as an output variable, and “REF” indicates that the variable is used as a reference variable.

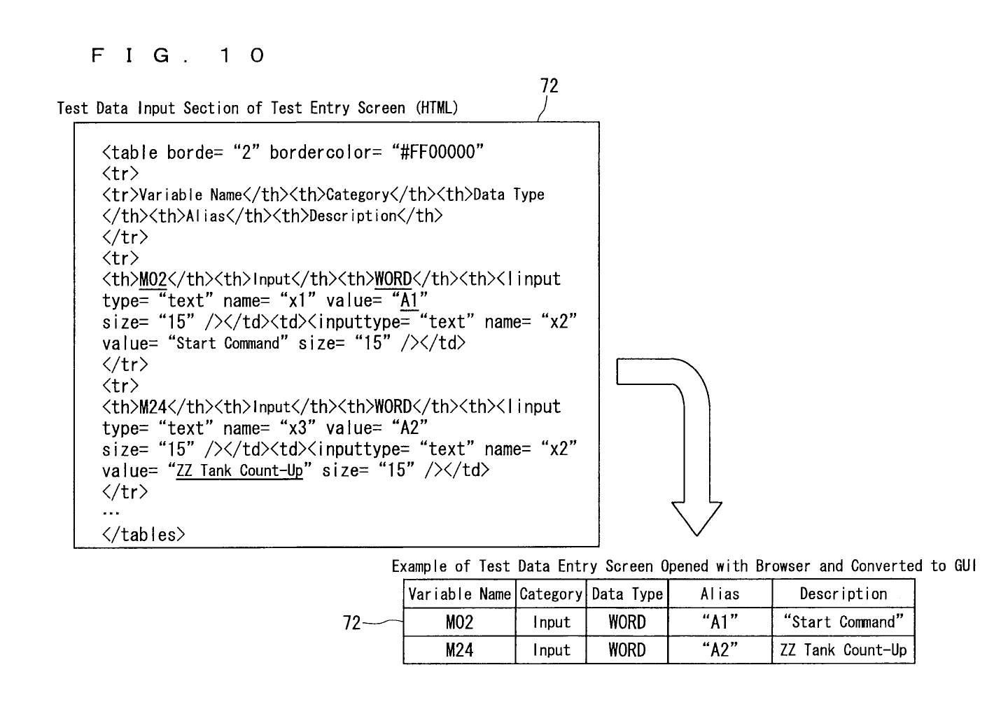

The attributes of the respective variables for use in each module are found from the variable information 81 obtained by the above-mentioned analysis. In accordance with the attributes, an entry screen for the variables included in each module is constructed. The entry screen is constructed for each module for the purpose of permitting the operator to enter information about a variable unobtainable by the analysis. FIG. 10 shows an example of a screen produced from the variable information 81 by using a markup language. Such a screen is easily produced by preparing a preformed screen such as a template. At this time, an alias is added to each of the variables automatically or by the operator entering the alias. This alias is used to identify a corresponding variable during the writing of the test. In an example of an entry screen 72 shown in FIG. 10, the operator is permitted to enter a description about each variable. However, as mentioned earlier, information obtained by the analysis is sufficient as the variable information in some cases, and the variable information need not always be obtained by the entry on the constructed entry screen. The variable information obtained in this manner is displayed on the program entry screen.

The input of the program 92 to be tested is thus completed, and information about the programs necessary for the test is obtained. Next, a test entry screen for the operator to enter test information necessary for the test, that is, what test is to be made is produced.

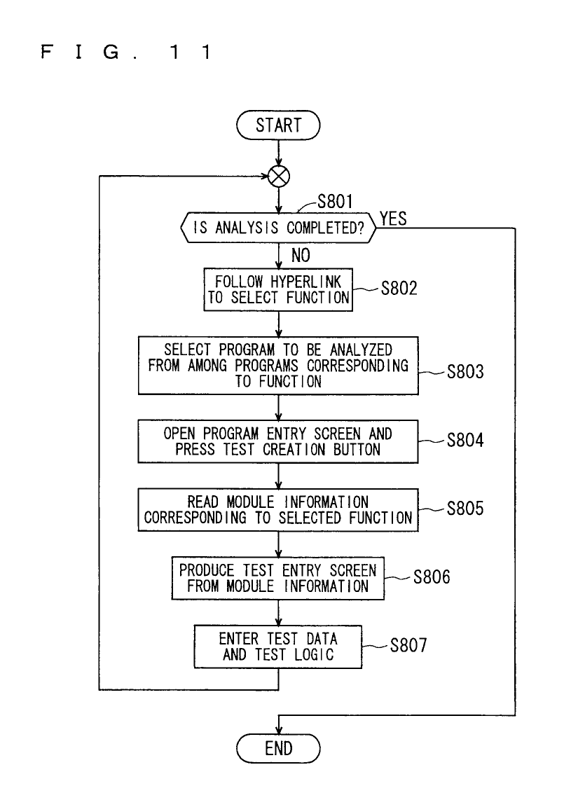

The operation of the test entry screen generating section 71 is shown in the flowchart of FIG. 11. First, an operator uses the keyboard 42 to cause the program entry screen to appear. In Step S801, when there is no program for producing the test entry screen, the operation is terminated. When there is a program for producing the test entry screen, the operator follows a hyperlink to select the function of entering a test (in Step S802). When the function is selected, the operator selects a program (in Step S803). The operator causes the program entry screen to appear, and presses a test creation button on the code entry screen (in Step S804). Then, module information is read (in Step S805) to produce the test entry screen (in Step S806). The operator enters input data and a test logic on the test entry screen (in Step S807).

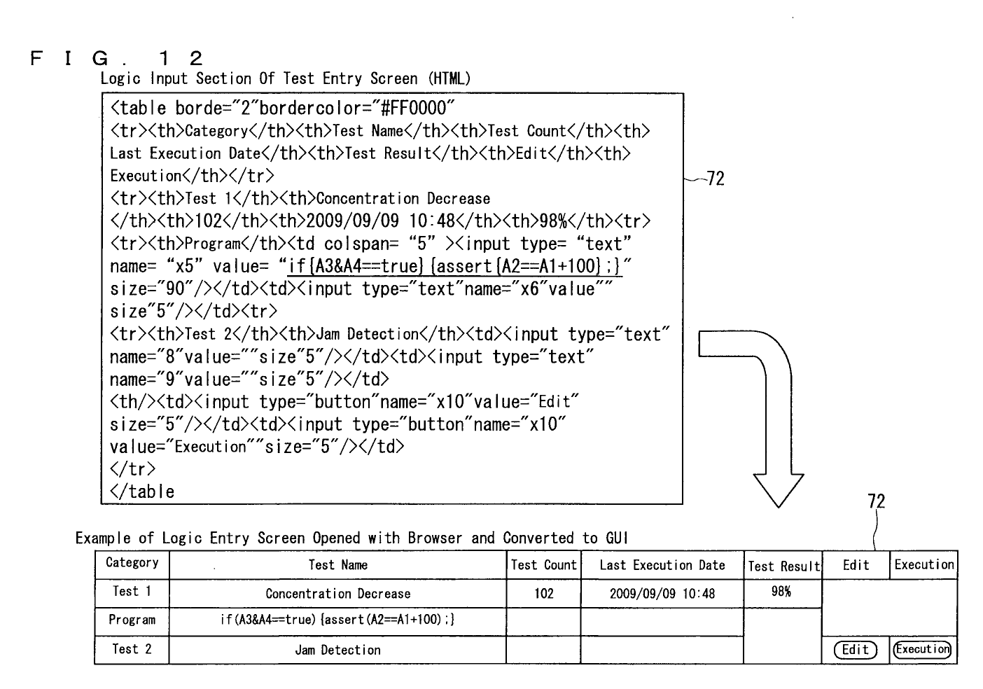

FIG. 12 shows a test logic entry screen section included in the test entry screen generated from the module information 89. In this section, the alias defined in the variable information 81 is used to write the logic “if (A3 & A4==true) {assert (A2==A1+100);}” using a script. This is a logic for detecting that, if one of the bit-type variables A3 and A4 is true, the WORD-type variable A2 that is not greater than the WORD-type variable A1 by 100 is abnormal. It is necessary for the operator to determine such a test logic for each test, and such a test logic cannot be automatically generated by the test entry screen generating section 71. For this reason, the entry screen 72 permits the operator to enter the test logic. Thus, such programmable conditions are adapted to be specified. This allows a test that simulates various states such as complicated conditions to be conducted.

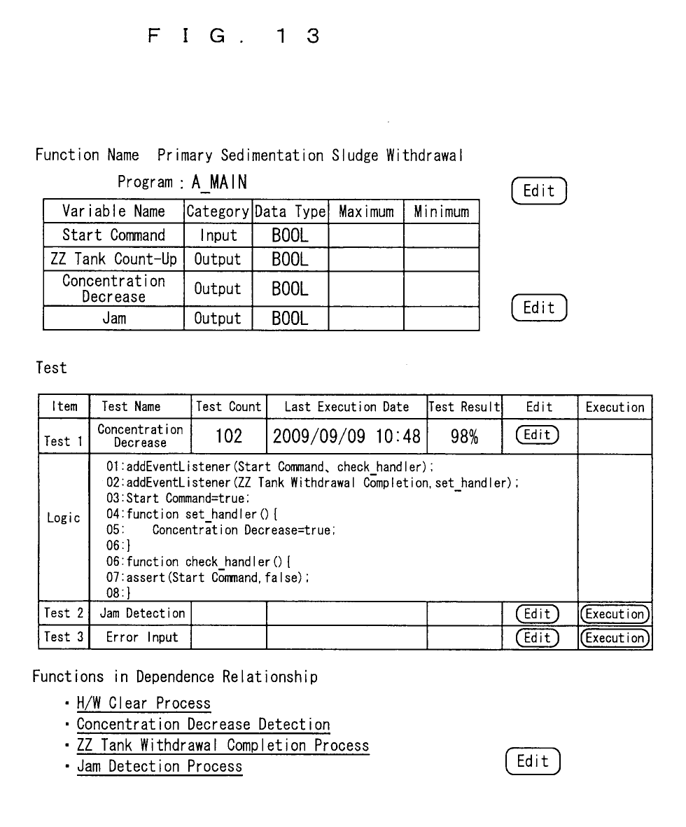

FIG. 13 shows an example of the produced test entry screen. The function name related to the module shown in FIG. 13 is “Primary Sedimentation Sludge Withdrawal,” and a test data entry screen section for variables used in the module is displayed on the test entry screen shown in FIG. 13. Pressing an edit button on the screen changes the current mode to an edit mode in which test data and logics may be edited.

Next, for the actual execution of a test, the test editing section 73 uses the test entry screen information 82 to cause the test entry screen as shown as an example in FIG. 13 to appear on the display section 2, thereby permitting the operator to enter a test logic and necessary test data. The entered test logic and a program for accessing variables of a program using aliases are combined together to produce the test program 83. The produced test program 83 together with the test input data 84 such as entered variable data is recorded in the test database 80.

In this manner, the test program 83 and the test input data 84 are prepared. Thereafter, when the operator presses an execution button, the test program executing section 74 reads the test input data 84 recorded in the test database 80 and the test program 83 written in a script to send the test program 83 and the test input data 84 to the loader 93. The loader 93 converts the test program 83 and the test input data 84 into a format executable in the PLC 94. Then, a test is executed in the PLC 94.

After the test is executed, the test program executing section 74 receives data about the result of execution from a memory of the PLC 94 to record the data as the test execution result 85 into the test database 80. The test result may be displayed on the display section 2. In this manner, the test program executing section 74 is capable of executing the test program in the PLC 94, and managing the result of the execution of the test (the test result) for each function on the basis of test execution.

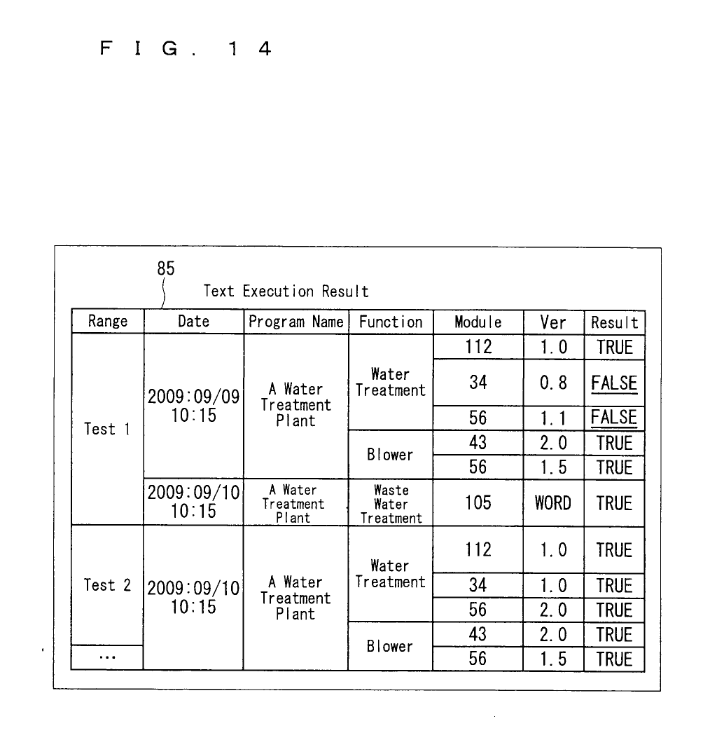

FIG. 14 shows an example of the test execution result 85 recorded in the test database 80. With reference to FIG. 14, this example of the test execution result 85 shows that a test related to an A water treatment plant is executed on a day-by-day basis, and that the test executed on modules 34 and 56 on September 9 is not successful whereas the modules 34 and 56 pass the test on the next day, i.e. on September 10, because the versions of the modules 34 and 56 are updated from 0.8 and 1.1 to 1.0 and 2.0, respectively. Thus, the centralized management of the test results allows the multilateral analysis from various aspects, e.g. on a function-by-function basis, on a module-by-module basis, and on the basis of data and time. This improves the efficiency of the test.

According to the first preferred embodiment, as described hereinabove, part of the module information and variable information which the program analyzing section is not able to automatically obtain by analysis are obtained by permitting the operator to enter the part of the module information and variable information. Additionally, the operator is permitted to enter a test logic and test data. This enables the program test to be executed under programmable conditions including combining a plurality of conditions together, considering time and state change, and using a test result under a condition as input data of another condition. Also, there is no need to previously produce the specifications of the plant because the programs corresponding to the components constituting the plant can be inputted. Further, a relationship between programs is analyzed in accordance with the specifications of the plant. This enables a related program to be easily found, independently of the volume of variables of the program.

### Second Preferred Embodiment

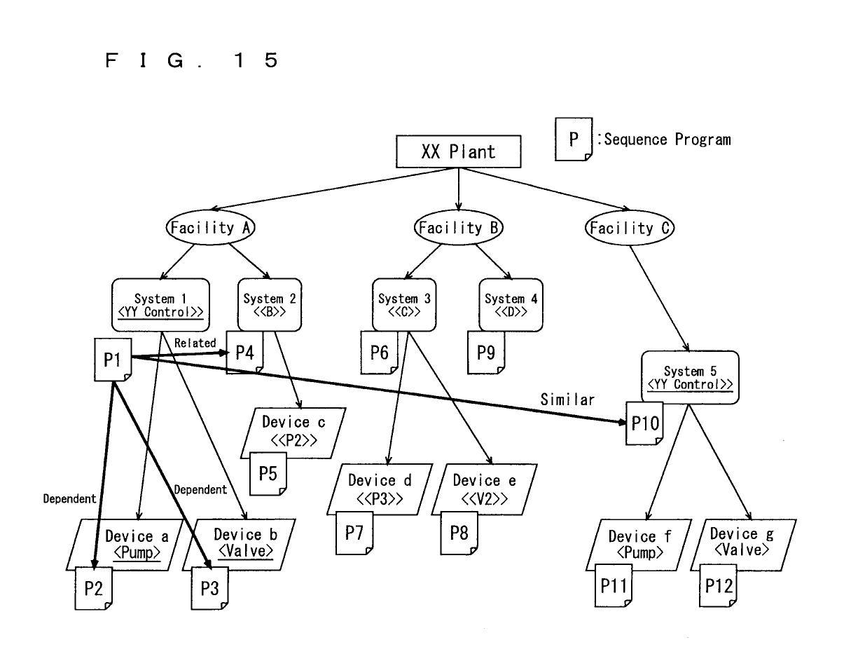

FIG. 15 shows an example of the system configuration of the plant for illustrating the operation of a program retrieving section 77 in the program testing apparatus according to a second preferred embodiment of the present invention. As shown in FIG. 15, facilities A to C are at a hierarchical level lower than that of the XX plant, and the facility A includes a system 1 and a system 2. The system 1 is a “YY control” type function, and is associated with a program P1. Similarly, the system 2 is a function having “B”-type control, and is associated with a program P4. The system 1 includes two devices: a device a and a device b. The device a is of a “pump” type, and is associated with a program P2. The device b is of a “valve” type, and is associated with a program P3. The ability to find a program related to the program P1 in a plant having such a system configuration without following the variables of the program is a characteristic of the present invention.

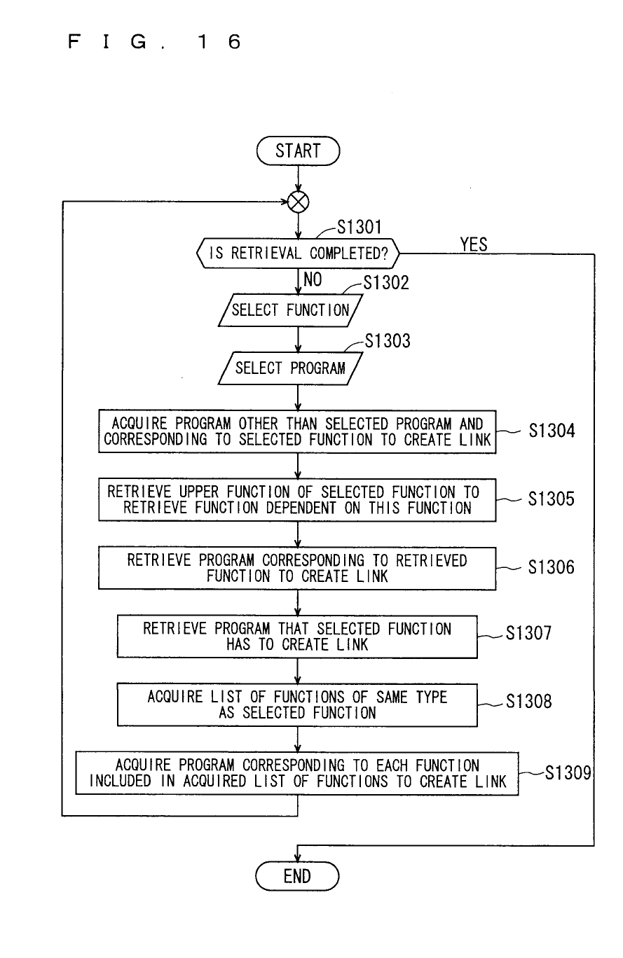

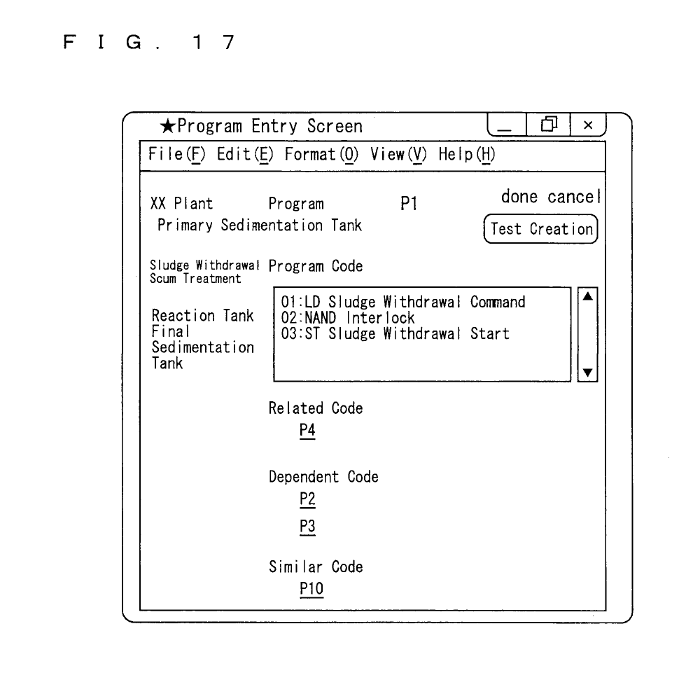

FIG. 16 is a flowchart illustrating the outline of the operation of the program retrieving section 77 according to the second preferred embodiment of the present invention. In Step S1301, when a program retrieval is completed, the operation is terminated. When the program retrieval is not completed, a function of a program to be retrieved is selected by following a hyperlink (in Step S1302). It is assumed that the selected function is the system 1. Next, the selected function entry screen selects the program to be retrieved (in Step S1303). It is assumed that the program to be retrieved is the program P1. In Step S1304, a program other than the selected program and related to the selected function, that is the system 1, is acquired. In this case, such a program is not present. Next, a second function whose upper function is the parent function, i.e. the facility A, of the selected function, i.e. the system 1, is retrieved (in Step S1305). In this case, the system 2 corresponds to the second function. In Step S1306, a list of programs corresponding to the function retrieved in Step S1305 is acquired. In this case, the program P4 corresponds to the system 2. A hyperlink to each of the components of the list as related programs is created. In Step S1307, a list of programs that functions dependent on the selected function have is acquired. A hyperlink to each of the components of the list as dependent programs is created. In this case, the programs P2 and P3 corresponding to the devices a and b, respectively, are the dependent programs. In Step S1308, a function of the same type as the selected device is retrieved. In this case, a system 5 corresponds to the function. In Step S1309, a list of programs corresponding to the function is acquired. A hyperlink to each of the components of the list as similar programs is created. In this case, a program P10 is the similar program. A program entry screen on which such results are reflected is shown in FIG. 17.

In other words, for a program corresponding to a single component, the program retrieving section 77 retrieves a similar program corresponding to a component which performs a process similar to that of the single component, a related program corresponding to a component having a hierarchically upper component immediately close thereto and common to the single component, and a dependent program corresponding to a component at a lower hierarchical level than that of the single component, based on the system information 87.

According to the second preferred embodiment, as described hereinabove, part of the module information and variable information which the program analyzing section is not able to automatically analyze are obtained by permitting the operator to enter the part of the module information and variable information, in a similar manner to that of the first preferred embodiment. Additionally, the operator is permitted to enter a test logic. This enables the program test to be executed under programmable conditions including combining a plurality of conditions together, considering time and state change, and using a test result under a condition as input data of another condition. In addition to this, the second preferred embodiment is capable of testing related functions. When it is judged that a test result is abnormal and there is a possibility that the program to be tested has a bug, the second preferred embodiment tests a function that has influence to thereby efficiently search for a bug. In other words, the second preferred embodiment is capable of easily retrieving a related program and a program of the component at the same hierarchical level without following variables. This prevents the occurrence of program errors.

While the invention has been described in detail, the foregoing description is in all aspects illustrative and not restrictive. It is understood that numerous other modifications and variations can be devised without departing from the scope of the invention.

What is claimed is:

1. A program testing apparatus comprising:
an input section;
a display section;
a controller; and
a test database,
said controller including
a program input section for receiving externally inputted program codes corresponding to system components disposed hierarchically in accordance with a plant system configuration to divide a program to be tested which is inputted from said input section into a plurality of modules on a function-by-function basis, based on said system components,
a program analyzing section for analyzing each of said modules to acquire system information about said system components based on said plant system configuration corresponding to each module and to acquire variable information for use in each module, based on said system information, thereby storing module information including said system information and said variable information in said test database,
a test entry screen generating section for producing a test entry screen for entry of a test logic and test data that are required for the execution of a program test for each module from said input section, by using said module information stored in said test database, to store test entry screen information for the construction of said test entry screen in said test database,
a test editing section for causing said test entry screen to appear on said display section by using said test entry screen information, and for producing a test program from the test logic entered using said test entry screen to store the produced test program and the entered test data in said test database,
a program retrieving section for retrieving a program having a predetermined relationship to a program corresponding to one of said system components, based on said system information, and
a test program executing section for executing said test program by using said test data stored in said test database to store a test result in said test database.

2. The program testing apparatus according to claim 1, wherein the program having the predetermined relationship in said program retrieving section includes a similar program corresponding to a system component which performs a process similar to that of said one of said system components, a related program corresponding to a system component having a hierarchically upper system component immediately close thereto and common to said one of said system components, and a dependent program corresponding to a system component at a lower hierarchical level than that of said one of said system components.

3. The program testing apparatus according to claim 1, wherein said test logic is written in a script.

4. A method of testing a program using a program testing apparatus, said method comprising the steps of:
(a) receiving externally inputted program codes corresponding to system components disposed hierarchically in accordance with a plant system configuration to divide an inputted program to be tested into a plurality of modules on a function-by-function basis, based on said system components;
(b) analyzing each of said modules to acquire system information about said system components based on said plant system configuration corresponding to each module and to acquire variable information for use in each module, based on said system information;
(c) storing module information including said system information and said variable information acquired in said step (b) in a test database;
(d) producing a test entry screen for entry of a test logic and test data that are required for the execution of a program test for each module, by using said module information stored in said test database, to store test entry screen information for the construction of said test entry screen in said test database;
(e) causing said test entry screen to appear on a display section by using said test entry screen information, and for producing a test program from the test logic entered using said test entry screen to store the produced test program and the entered test data in said test database;
(f) retrieving a program having a predetermined relationship to a program corresponding to one of said system components, based on said system information; and
(g) executing said test program by using said test data stored in said test database to store a test result in said test database.

5. The method according to claim 4, wherein the program having the predetermined relationship in said step (f) includes a similar program corresponding to a system component which performs a process similar to that of said one of said system components, a related program corresponding to a system component having a hierarchically upper system component immediately close thereto and common to said one of said system components, and a dependent program corresponding to a system component at a lower hierarchical level than that of said one of said system components.

6. The method according to claim 4, wherein said test logic is written in a script.

7. A program testing program for causing a computer to function as a program testing apparatus, said program testing program causing said computer to execute the steps of:
(a) receiving externally inputted program codes corresponding to system components disposed hierarchically in accordance with a plant system configuration to divide an inputted program to be tested into a plurality of modules on a function-by-function basis, based on said system components;
(b) analyzing each of said modules to acquire system information about said system components based on said plant system configuration corresponding to each module and to acquire variable information for use in each module, based on said system information;
(c) storing module information including said system information and said variable information acquired in said step (b) in a test database;
(d) producing a test entry screen for entry of a test logic and test data that are required for the execution of a program test for each module, by using said module information stored in said test database, to store test entry screen information for the construction of said test entry screen in said test database;
(e) causing said test entry screen to appear on a display section by using said test entry screen information to enter the test logic and the test data;
(l) producing a test program from said test logic entered in said step (e);
(g) retrieving a program having a predetermined relationship to a program corresponding to one of said system components, based on said system information; and
(h) executing said test program by using said test data entered in said step (e) to store a test result in said test database.

8. The program testing program according to claim 7, wherein the program having the predetermined relationship in said step (g) includes a similar program corresponding to a system component which performs a process similar to that of said one of said system components, a related program corresponding to a system component having a hierarchically upper system component immediately close thereto and common to said one of said system components, and a dependent program corresponding to a system component at a lower hierarchical level than that of said one of said system components.
